(19) United States
(12) Patent Application Publication
(10) Pub. No.: US 2003/0004752 A1
(43) Pub. Date: Jan. 2, 2003

(54) Method and apparatus for web based multiparty counseling

(75) Inventors: Dwip N. Banerjee, Austin, TX (US); Rabindranath Dutta, Austin, TX (US)

Correspondence Address: Andrea Pair Bryant, 5202 Vista West Cove, Austin, TX, 78731, US

(73) Assignee: International Business Machines Corporation, Armonk, NY (US)

(21) Appl. No.: 09/893,471

(22) Filed: Jun. 28, 2001

(51) Int. Cl. G06F 17/60

(52) U.S. Cl. 705/2

(57) ABSTRACT

A method and apparatus are provided for conducting counseling over the Internet. A server is provided for establishing, controlling and tracking sessions which may include plural patients and one counselor or one counselor and one patient. Each counselor may be simultaneously involved in plural sessions, i.e., it appears to each individual patient that he/she is engaged in one on one counseling. Counselors are thereby able to increase their workload while also able to track their time per patient counseled in order to bill appropriately.

### BACKGROUND of the INVENTION

1. Technical Field

The present invention relates to the provision of counseling services over the Internet. More specifically, it relates to enabling plural counselors to individually interact with plural persons desiring such counseling services, privately or as part of a group. Further, the present invention provides for communication during a counseling session between a person being counseled and other(s) not part of the counseling session.

2. Description of the Related Art

Many people seek counseling, but due to time constraints are unable attend in person sessions. Efforts have been made to provide remote access to counselors or similar service providers. In the past they have been able to participate via telephone. Systems are known wherein a pharmacist or psychological counselor can interact with plural patients by phone. Some computer implemented systems also rely on telephone connections even when some communication takes place my means of the Internet and multimedia communication.

Exemplary prior art includes the following references. U.S. Pat. Nos. 5,960,069 and 5,894,510 to Felger disclose a group conferencing arrangement permitting simultaneous connection of two or more service representatives to a given call-in caller.

U.S. Pat. No. 5,980,447 to Trudeau discloses an interactive multimedia computing system for providing support to a recovering substance abuser. Included is an option for the person in recovery to participate in on-line group support discussions.

U.S. Pat. No. 5,666,492 to Rhodes et al. discloses a computer based pharmaceutical care cognitive services management system for use by a pharmacist in phone or in person contact with one or more patients.

U.S. Pat. No. 5,951,469 to Yamaura discloses a server based remote medical system including telephone lines for enabling a pre-registered counseling doctor to quickly respond to a counselee.

The evolution of the Internet offers significant opportunities for distributed and group based interaction among people interested in achieving common goals. Group based psychological counseling may combine the best elements of individual counselor—patient sessions and conventional group therapy; and make both counseling models available in a more time and cost efficient manner. That is, enabling counseling to place in a secure environment without necessitating travel by patients to a counselor would save time and expense for all involved. It is therefore, desirable to provide individual and group therapy services utilizing the advantages the Internet makes possible.

The prior art, while using the Internet, relies on telephone communication as well. It would be desirable to allow all communication in an on-line multiparty counseling service to take place via the Internet.

### SUMMARY OF THE INVENTION

The present invention allows such communication among and between counselors, persons seeking counseling (hereinafter referred to as patients) and others persons invited (invitees) into counseling sessions by providing a counseling server, appropriately programmed for access by a plurality of client computers associated with plural counselors and plural patients, for delivering interactive counseling using multimedia conferencing.

In one aspect the present invention allows a given counselor to simultaneously interact with plural patients. In another aspect, individuals engaged in a counseling session may also engage in ‘off-line’ communication with people not in the counseling session.

In still another aspect, the present invention provides for counseling sessions comprising plural patients and a counselor.

These and other features and advantages are achieved by enabling the counseling server to maintain a roster of counselors by specialty and availability, which counselors may be assigned as needed to individual patients and patient groups for online counseling sessions. The counseling server is able, at the option of a user patient, to invite at least another person into the session. Counselors are able to request from the counseling server transcripts of sessions in which they participate. Billing and time management functions are also performed by the counseling server.

Other features of the counseling server include monitoring patient usage for billing and other administrative uses and a registration protocol for all counseling session participants.

### BRIEF DESCRIPTION OF THE DRAWING

The above and other features and advantages of the present invention will be better appreciated from the following description taken in conjunction with the accompanying drawings wherein like reference numerals and labels are used throughout to denote the same elements and wherein:

FIG. 1 is a structural diagram of a system including the present invention;

FIG. 2 illustrates the functional components of counseling server 10 of FIG. 1;

FIG. 3 shows a counselor's screen shot;

FIG. 4 shows a patient's screen shot;

FIG. 5 illustrates the logic flow of the operation of the invention; and

FIG. 6 illustrates the functional flow within counseling server 10.

### DETAILED DESCRIPTION OF A PREFERRED EMBODIMENT

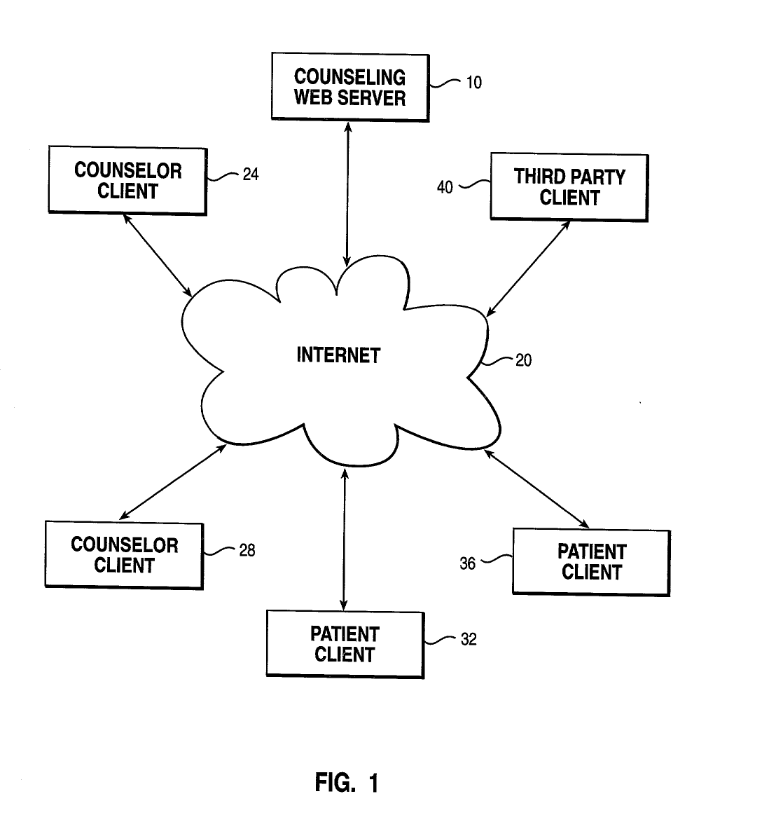

Refer now to FIG. 1, which shows the principal elements of a system including the counseling server of the present invention. Counseling Server 10 is shown connected to the Internet 20. Selectively connected to Counseling Server 10 via Internet 20 are client systems such as counselor A 24, counselor B 28, patient X 32 seeking counseling and patient Y 36 seeking counseling. Various third party invitees 40 to sessions may be selectively included by patients, as will be explained below.

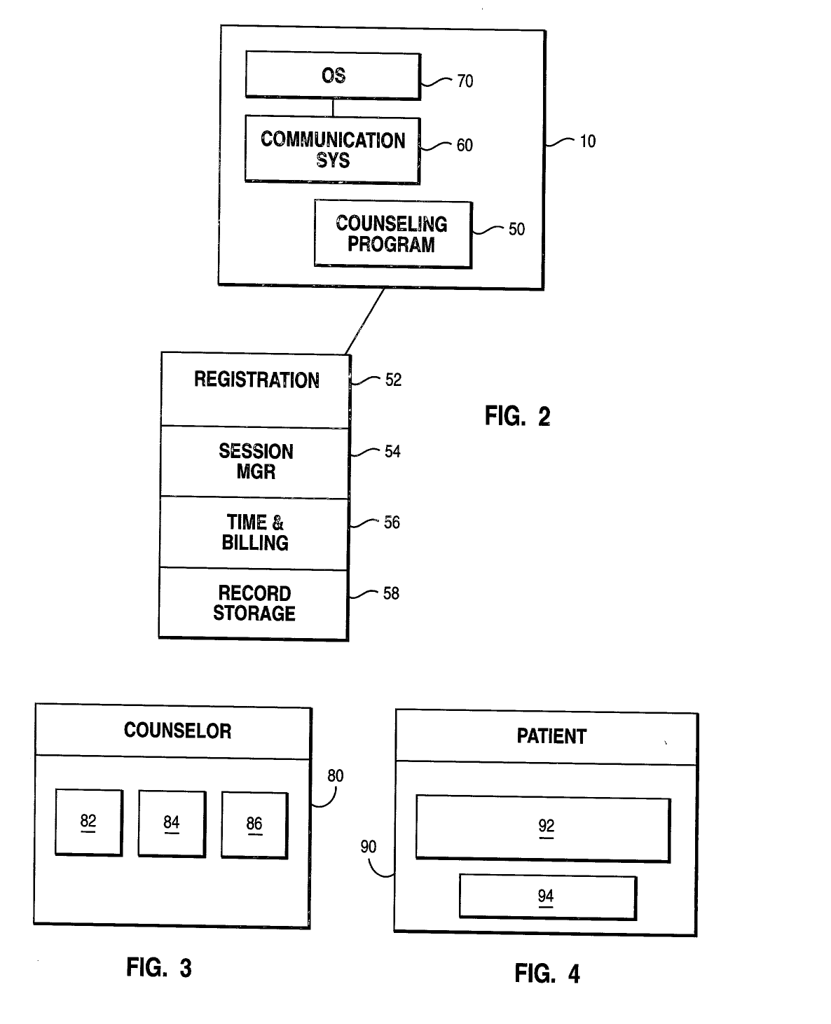

FIG. 2 shows in greater detail the primary components of Counseling Server 10. Counseling program 50 is provided for setting up and administratively tracking counseling sessions. Counseling program 50 performs a variety of functions. A primary function concerns maintaining a current roster of counselors by name, specialty and availability. Another function relates to registration and verification of patients seeking counseling.

Counseling program 50 also assembles groups of counseling session participants. Groups are comprised of the people at client systems (e.g. 24, 36, 40, FIG. 1) who communicate via the Internet during a counseling session.

An important feature of a system embodying the present invention is the enabling of a single counselor to counsel plural persons in a manner such that each person is in fact engaged in a one on one session. This advantage arises from the use of the Internet as the principle communication medium. Counseling program 50 assembles one or more patients seeking counseling with a counselor chosen from the roster of counselors by name and/or specialty and availability. Thus, a given counselor is able to serially interact with several persons seeking counseling while to each person the appearance is that of a one on one session. Counseling program 50 is able to keep track of the actual session time per patient seeking counseling as well as the counselor's time by counselor and patient(s). In this manner billing to each person may be achieved and the counselor is properly compensated.

FIG. 2 illustrates the principle components of the counseling server 10 of the present invention. Counseling server 10 performs a variety of functions. Counseling server 10 is an Internet server, as shown in FIG. 1, and as such is addressable by counselors and those seeking counseling. The primary component of counseling server 10 is counseling program 50. Program 50 provides the essential features of the present invention.

As is well understood by those having skill in the art, counseling program 50 executes in conjunction with communications Web server 60 under control of operating system 70.

Returning now to program 50, it maintains a roster of patients with their pertinent identification, insurance, history, and like data. Further, program 50 maintains a roster of counselors by name and specialty, ongoing patient relationships, and similar data. These types of patient and counselor data are set forth for illustrative purposes only. The types and formats of data maintained are clearly implementation dependent. For example, were a system embodying the present invention implemented as an in house employee service for a large corporation or institution, the types and depth of data necessary would be understandably different than that needed to operate a system implemented for HMO members or one operated for anyone who chose to subscribe.

Another important function performed by program 50 may be generally termed time and billing. Again, the details about such functions and the nature and content of data needed are entirely implementation dependent. That is, information needed for pay as you go patient billing is quite different than that for prepaid patients.

A system may be set up to bill patients every time they access the system. An employee assistance plan may offer a number of sessions free of charge, regardless of session length. Still another form of system may be set up for a onetime billing for a certain number of minutes, much like a prepaid phone card.

In any implementation, it is desirable to keep records of counselor time and patient load, whether they are compensated by time on line with patients and/or number of patients counseled. Counselor rates could obviously vary by specialty, by whether patients are counseled in groups or individually and by other professional factors. Thus, an accounting and billing module tailored to the implementation may be interconnected with program 50.

The overriding function performed by program 50 relates to establishing and terminating sessions. Program 50 is responsible for displaying menus through which patients enroll in and thereafter access the system. Program 50 matches patient indicated choices with available counselors. Still another aspect of program 50 is the capability to allow a patient signing on, based on the nature of the subject of counseling sought, the opportunity to enter an ongoing group session.

Another feature of program 50 is the capability to allow patients to communicate with others, not party to the patient counselor session, while the session is underway. Those having skill in the art will appreciate that any or all of the above mentioned options, or some others not included, may be incorporated into program 50.

For simplicity, program 50 is illustrated having its major components only. Registration module 52 includes the code necessary to register patients and counselors. Session manager module 54 provides control of communication aspects of individual and group sessions. It also provides control over private communication between patients and people of their choice. Time and billing module 56 provides the capability of tracking online time of each patient and counselor. Storage module 58 is provided for maintaining patient rosters and files as well as counselor information. Clearly data security measures are integrated throughout program 50 but especially with regard to patient records.

Refer now to FIG. 3, which illustrates a sample screen shown to a counselor. Screen 80 displays a window for each patient with whom the counselor is currently engaged. Windows 82, 84, 86 contain the most recent input from the respective patient and the counselor's reply. At the counselor's option, a printed transcript of each session may be obtained.

FIG. 4 illustrates a sample screen display for an individual patient. Screen 90 contains a window 92 which displays counselor comments and allows the patient to input information. If a patient is part of a group session window 92 displays information input by all participants in the session. Window 94 is reserved for private patient communication with a third party invitee not included in the session. Program 50 establishes such a private session if requested by the patient. Part of session establishment by program 50 includes inquiring of the proposed third party invitee their willingness and availability to participate and thereafter advising the patient of the third party invitee's response prior to enabling actual communication.

Referring to both FIG. 3 and FIG. 4, the contents of window 82 on the counselor's screen and window 92 on a patient's screen would be the same when the patient and counselor are engaged in a counseling session. Thus, the patient perceives him/herself in a one on one session while, in fact, the counselor is participating in three one on one counseling sessions substantially simultaneously.

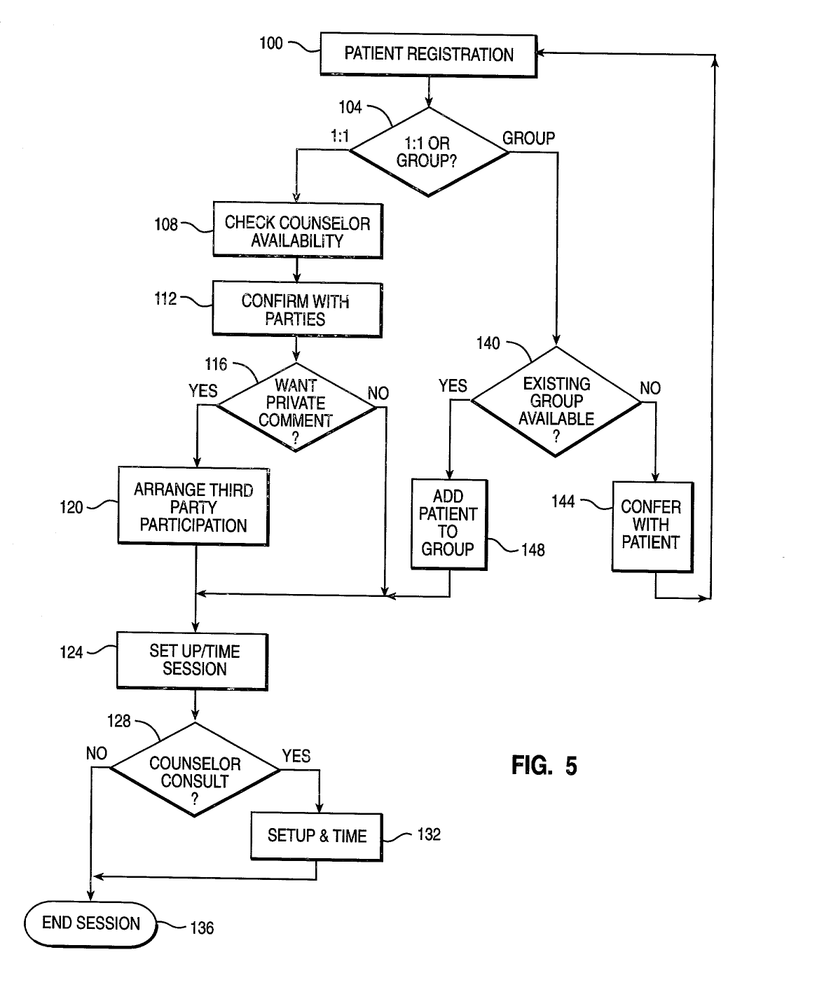

FIG. 5 depicts, from a patient perspective, an exemplary, high level logic flow during operation of a system including the present multiparty counseling server. Details of communications protocol and programming the features described above is believed to be within the skill of the art. The present invention relates to the administration of an Internet enabled multiparty counseling system wherein virtual group and one on one therapy sessions are dynamically established.

Patient registration step 100 represents the many aspects of patient sign-in. Program 50 interactively, using e.g. questionnaire(s) and menu choices, determines, inter alia, whether the requester is a new or returning patient, payment basis, nature of subject matter for which counseling is sought, specific counselor preference, and creates or updates records accordingly. At decision step 104 the requester indicates whether a one on one or group session is preferred.

If one on one counseling is desired, program 50 at step 108 checks counselor availability. This check would include whether a specific counsel, if requested, is available and taking patients. Otherwise, program 50 finds a counselor based on availability and expertise in the subject matter area. Step 112 represents program 50 confirming with both the requester and counselor a session date, time and the like. Obviously, a session could be established immediately, if feasible and the parties agree. For this level of communication program 50 could advantageously utilize instant messaging.

At query 116, program 50 ascertains whether the requester wants to use to private conversation feature of the present invention. If private conversation is to be included in a session, program 50 must make arrangements therefor at step 120. Included in step 120 is contact with the third party(ies) the requester want to include as passive participants in the session. That is, the third party(ies) may observe the interchanges between the counselor and patient but communicate only with the patient. Program 50 appropriately advises the patient of his/her invitee(s) willingness and availability to participate.

If at step 116 the patient responded no to the option of inviting a third party, program 50 branches to step 124 and proceeds to dynamically set up and monitor elapsed time of the session. Program 50 reaches step 124 after arrangements for third party participation have been completed.

It should be clear that program 50 allows for a time lapse before step 124 actually occurs. As mentioned earlier, program 50 may accommodate immediate session set up, but more than likely some scheduling coordination will occur. Step 124 represents iterative communication between the patient and counselor. Further, it includes private communication events between the patient and his/her invited third parties. In any case, program 50 records patient and counselor time for administrative purposes.

Another feature of counseling program 50 permits counselors to consult with each other, during a session or at other points in time. If a counselor needs to consult a colleague during a session as indicated at decision point 128. If the counselor needs a consultation program 50 sets up and times the communication between counselors at step 132. Again, this communication event may be iterative.

The session ends at step 136 with program 50 taking care of scheduling subsequent appointments and closing out the administrative records for the just concluded session. Step 136 also includes offering the counselor the option of receiving a transcript of the just concluded session.

If at decision step 104 the requesting patient expressed a preference for a group counseling experience, program 50 must determine at step 140 whether a suitable group has already been established. If no suitable group based on subject matter area with an opening is found, program 50 so advises the patient at step 144. Step 144 includes exchanges with the patient regarding patient preferences as to waiting to a new group to be assembled by program 50 or going into one on one counseling. At this juncture, program 50 returns to patient registration step 100, from which the patient may terminate his/her access to the system.

If an appropriate group is found at step 140, then program 50 adds the patient to the group at step 148. This step contemplates conferring with the counselor and other group members. Once all pertinent parties agree, program 50 branches to step 124. A system including the present multiparty counseling server may also allow group therapy participants the option of having passive third party invitee participants insofar as individual patients are concerned. Of course in such a case, from step 148 the program would branch to step 116, and the third party invitee would be precluded from access to input provided by other session patient participants.

For group sessions step 124 includes enabling real time communication among all participants and maintaining suitable records of time for each in order to facilitate billing and other administrative functions. For group sessions a counselor is also able to selectively consult with one or more colleagues in much the same manner that a patient is able to consult a third party invitee.

The counseling program 50 of the present invention is susceptible to great customization. It has been described in an exemplary psychological counseling system, but is adaptable to other uses such as parent teacher conferences and affinity group environments.

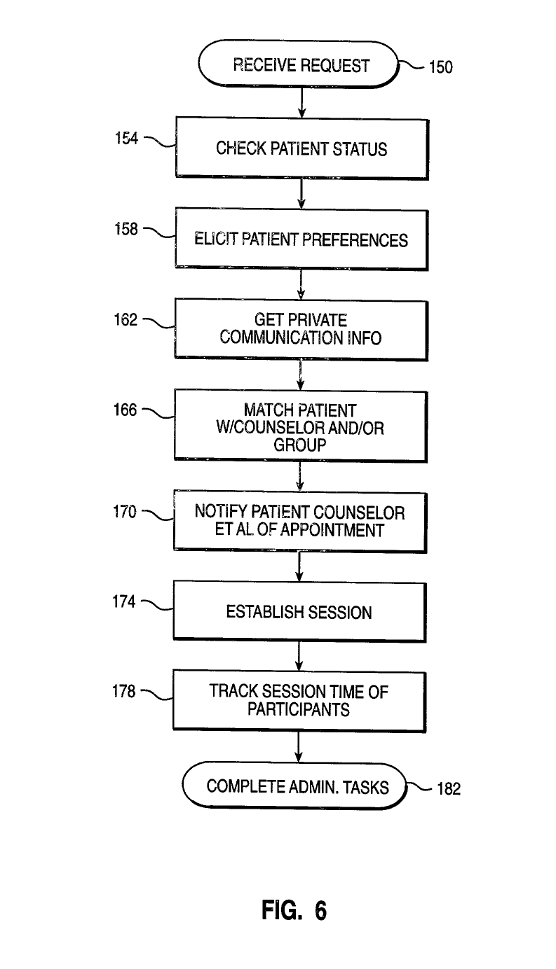

FIG. 6 illustrates functional flow within counseling server 10 from the perspective of the server upon access by a patient seeking counseling. Counseling server 10, under control of counseling program 50, receives a request as indicated at 150. The first function to be accomplished is to check patient status at 154. This function may include such aspects of patient status as: whether it the first or a return visit, whether the patient is part of a prepaid plan, how payment is to be made.

When a patient seeks counseling for the first time, it is necessary for the patient to register and thereby create a record. Records for return visit patients are appropriately updated. Server 10 then accepts patient preferences as interactively elicited at 158 by counseling program 50. Patient preferences may be sought for such variables as whether the patient wants one on one counseling or is interested in be part of group therapy session. The patient would be prompted to indicate the general category counseling desired such as career stress, coping with teenagers, relationship maintenance and the like. In any event, the patient is prompted to enter the time frame in which a counseling appointment is wanted, immediately or otherwise. Those having skill in the art will appreciate that other preference areas could be specified in implementation specific circumstances.

Another option for any patient is represented at 162. A patient may wish to engage in private communication with a third party while the patient is participating in a counseling session. If that is the case, the patient would be prompted to supply the information necessary for server 10 to establish a communication session with such a third party at a client system remote from that of the patient.

Server 10 thereafter proceeds at 166 to match the patient with a therapist for counseling. A patient may have specified a particular counselor thereby simplifying the matching process. If no counselor has been specified, counseling program 50 searches a previously stored roster of counselors by specialty and availability within a time frame posed by the patient seeking counseling. Confirmation of an appointment for a counseling session is made at 170 by notifying all involved parties: patient; counselor; and any third party with whom the patient has indicated a desire to communicate privately during the session.

At the appointment time previously confirmed, a counseling session is established as represented at 174. The session includes the parties with whom it has been confirmed. It will be recalled that a patient may have indicated a preference to be in a group therapy session. Thus, at the appropriate time all patients participating in a group as set up and administered by counseling program 50 are prompted access the system. Such prompting may occur via an e-mail, instant message, or the like, from server 10.

Once a session is established and all parties are online, counseling program 50 tracks patient(s) and counselor time at 178 without intruding on the confidentiality of the session. As the session proceeds with a patient and counselor communicating using windows displayed by counseling program 50 as described above in connection with FIGS. 3 and 4, time is recorded in accord with implementation specific rules.

At the end of a session, administrative tasks related to patient and counselor record updates, billing, and the like are accomplished within server 10. Counseling program 50 would send a transcript of the session to the counselor if such has been requested.

The above mentioned and other modifications in form and detail may be made without departing from the spirit and scope of the claims which follow.

What is claimed is:

1. A method for providing an interactive counseling session, comprising:
receiving a counseling request from at least one patient via a computer network;
in response to receipt of said counseling request, identifying a counselor; and
establishing an interactive counseling session between said at least one patient and the and the identified counselor.

2. The method of claim 1 including the additional steps of:
before said establishing step, interactively determining session preferences from said at least one patient; and
at session end, handling administrative tasks including updating time records for said at least one patient and said counselor.

3. The method of claim 2 including the step of:
during an interactive counseling session, storing elapsed time for said at least one patient and said counselor.

4. The method of claim 3 wherein said identifying step includes:
consulting a stored roster of counselors maintained by specialty and availability.

5. The method of claim 4 wherein said receiving step includes:
determining whether said at least one patient desires to engage in private communication via a computer network with at least one third party during an interactive counseling session;
responsive to said determining step, contacting said at least one third party for learning whether said at least one third party is available to participate in said interactive counseling session; and
if so, establishing communication between said at least one third party and said patient.

6. The method of claim 5 comprising the additional steps of:
inquiring whether said counselor desires, during said interactive counseling session, consultation with at least a different counselor; and
responsive to said inquiring step, establishing private communication between said counselor and said at least a different counselor.

7. The method of claim 6 wherein said receiving step additionally comprises:
eliciting from said at least one patient a subject matter preference, a counselor preference and whether a one on one or group counseling session is requested.

8. The method of claim 7 including the additional steps of:
responsive to said eliciting step seeking an existing appropriate group;
in response to said seeking step indicating desirability of group counseling, verifying agreement of all patients in said existing group to accept said patient as a new group member;
responsive to a negative outcome from said verifying step, advising said patient; and
thereafter inquiring of said patient a willingness to wait until at least another patient indicates willingness to be in a new group.

9. The method of claim 8 wherein said receiving step additionally includes:
determining when said patient wishes an appointment for said interactive counseling session; and
scheduling an appointment before said establishing step.

10. The method of claim 1 including the additional step of:
selectably providing a transcript of said interactive counseling session to said counselor.

11. Apparatus for providing an interactive counseling session, comprising:
means for receiving a counseling request from at least one patient via a computer network;
means operable in response to receipt of said counseling request, for identifying a counselor; and
means for establishing an interactive counseling session between said at least one patient and the and the identified counselor.

12. The apparatus of claim 11 additionally including:
means, active before said means for establishing, for interactively determining session preferences from said at least one patient; and
means active at session end, for handling administrative tasks including updating time records for said at least one patient and said counselor.

13. The apparatus of claim 12 further including:
means active during an interactive counseling session, for storing elapsed time for said at least one patient and said counselor.

14. The apparatus of claim 13 wherein said means for identifying includes:
means for consulting a stored roster of counselors maintained by specialty and availability.

15. The apparatus of claim 14 wherein said means for receiving includes:
means for determining whether said at least one patient desires to engage in private communication via a computer network with at least one third party during an interactive counseling session;
means responsive to said means for determining, for contacting said at least one third party for learning whether said at least one third party is available to participate in said interactive counseling session; and
means, active if said at least one third party is available, for establishing communication between said at least one third party and said patient.

16. The apparatus of claim 15 further comprising:
means for inquiring whether said counselor desires, during said interactive counseling session, consultation with at least a different counselor; and
means, responsive to said means for inquiring, for establishing private communication between said counselor and said at least a different counselor.

17. The apparatus of claim 16 wherein said means for receiving additionally comprises:
means for eliciting from said at least one patient a subject matter preference, a counselor preference and whether a one on one or group counseling session is requested.

18. The apparatus claim 17 further including:
means responsive to said eliciting step for seeking an existing appropriate group;
means, active in response to said means for seeking, for indicating desirability of group counseling, verifying agreement of all patients in said existing group to accept said patient as a new group member;
means, responsive to a negative outcome from said means for verifying, for advising said patient; and
means, thereafter active, for inquiring of said patient a willingness to wait until at least another patient indicates willingness to be in a new group.

19. The apparatus of claim 18 wherein said means for receiving additionally includes:
means for determining when said patient wishes an appointment for said interactive counseling session; and
means for scheduling an appointment before said establishing step.

20. The apparatus of claim 11 including the additional step of:
means selectably operable by said counselor for providing a transcript of said interactive counseling session to said counselor.

21. A computer program product for managing interactive multiparty counseling sessions comprising:
means for selectively connecting via a computer network with one or more of a plurality of counselors;
means for receiving via a computer network a request for counseling from at least a patient; and
means, operable in response to said means for receiving, for initiating a counseling session between a counselor and at least a patient.

22. The computer program product of claim 21 wherein said means for receiving comprises:
means for determining a status for a patient requesting counseling; and
means for interactively learning patient preferences.

23. The computer program product of claim 22 wherein said means for learning additionally includes:
means for eliciting from said patient a subject matter preference;
means for eliciting from said patient a counselor preference; and
means for eliciting from said patient whether a one on one or group counseling session is desired.

24. The computer program product of claim 21 wherein said means for initiating additionally includes:
means for polling a roster of counselors specializing in said subject matter;
means for choosing a counselor from said roster as a function of availability to counsel; and
means, in response to said means for choosing, for assigning a chosen counselor to said patient.

25. The computer program product of claim 21 additionally comprising:
means for establishing a group counseling session for a plurality of patients and a counselor.

26. The computer program product of claim 25 wherein said means for establishing includes:
means for determining whether a group already exists;
if so, upon verifying agreement of patients in said existing group, means for adding a new patient; and
if not, means for advising a patient and determining whether said patient will wait until at least another patient is willing to be in a new group.

27. The computer program product of claim 25 additionally including:
means for maintaining a roster of counselors by availability and specialty;
means for maintaining patient usage and payment records;
means for establishing and managing multiple communication events among said patients and said counselors; and
means for scheduling subsequent individual and group sessions for said patients and said counselors.

28. The computer program product of claim 27 additionally comprising:
means for establishing communication between a patient and a third party client during a session between said patient and a counselor.

29. The computer program product of claim 28 additionally including:
means for selectively establishing communication among a plurality of counselors.

30. The computer program product of claim 29 wherein said scheduling means comprises:
instant messaging means for contacting said patients and said counselors.

31. Apparatus for managing an interactive, multiparty counseling service comprising:
means for receiving a request for counseling from a patient;
means for determining patient status;
means responsive to said means for determining for updating or creating a patient record;
means for eliciting patient preferences;
first means responsive to said means for eliciting for obtaining information for a third party participant;
second means responsive to said means for eliciting for finding a counselor and group for said patient;
third means responsive to said eliciting means for scheduling an appointment for said patient;
means responsive to said means for finding for notifying a counselor and group of said patient's upcoming appointment;
means, active at appointment time, for setting up a communication session among said patient, said counselor, said group and any third party;
means selectively operable for providing a session transcript to said counselor; and
means for tracking and storing session metrics for administrative purposes.
